(19) United States
(12) Patent Application Publication
(10) Pub. No.: US 2007/0122594 A1
(43) Pub. Date: May 31, 2007

(54) Crush-resistant, acoustically effective floor covering for motor vehicles

(76) Inventor: Kay Kosar, Wolfsburg (DE)

Correspondence Address: WILLIAM COLLARD;COLLARD & ROE, P.C., 1077 NORTHERN BOULEVARD, ROSLYN, NY, 11576, US

(21) Appl. No.: 10/573,845

(22) PCT Filed: Dec. 9, 2004
(86) PCT No.: PCT/EP04/14021

§ 371 Date: Mar. 29, 2006

(30) Foreign Application Priority Data
Dec. 12, 2003 (DE) 203 19 429.2

(51) Int. Cl. B32B 3/00; B32B 1/00

(52) U.S. Cl. 428/174; 428/166; 264/188

(57) ABSTRACT

The invention relates to a crush-resistant acoustically effective floor covering for a motor vehicle, in particular a commercial vehicle, comprising a decorative layer (2) and a crush-resistant blow moulded part (3) arranged underneath the decorative layer. In order to ensure an impeccable appearance of such a floor covering and in order to attain improved acoustic effectiveness while ensuring optimum crush-resistance, it is proposed that, on the top, the blow moulded part (3) comprise an essentially closed cover plate (5) while on the bottom it comprise a structural component (6), wherein the cover plate (5) and the structural component (6) have different wall thicknesses (d1, d2). The structural component (6) comprises a plurality of box-shaped or cup-shaped hollow chambers (7) which are open on one side but closed on the underside, wherein at least some of the hollow chambers (7) which are closed off to the outside form part of a common air space enclosed between the cover plate (5) and the structural component (6). Furthermore, the structural component (6) is underfoamed with foam material (4).

The invention relates to a crush-resistant, acoustically effective floor covering for motor vehicles, in particular commercial vehicles, comprising a decorative layer and a crush-resistant blow moulded part arranged underneath the decorative layer.

The floor of the passenger compartment of vehicles, in particular of utility vehicles, is these days as a rule carpeted. Up to now, frequently a design has been selected, in which in order to ensure good crush-resistant qualities, the carpet floor covering is placed on a self-supporting wooden panel or is glued to such a wooden panel. Usually a layer of foam material is arranged between the wooden panel and the floor pan (floor section) of the vehicle so as to compensate for any unevenness in the floor pan and so as to improve sound insulation and/or thermal insulation. While such floor designs provide adequate crush-resistant qualities, they are however relatively heavy and relatively expensive. Furthermore, the materials combination comprising carpet floor covering, wood and foam material is difficult to dispose of or recycle.

DE 196 27 106 A1 describes a sound-insulating insert for lining the underside of the carpet floor covering of a motor vehicle. In one embodiment the insert consists of a crush-resistant and stable blow moulded part that serves as a support body. The blow moulded part comprises a closed top and bottom. The top comprises a plurality of indentations. On the side facing the floor, the indentations are closed off so as to be airtight and are inter-connected by way of connection channels also formed in the top of the blow moulded part so as to make possible an exchange among the individual air volumes defined by the indentations so that said individual air volumes form a single large volume. The top of the blow moulded part furthermore comprises indentations for accommodating lines, in particular electrical lines. The indentations in the top of the blow moulded part are provided with an air-permeable cover layer on which the carpet floor covering is arranged. Furthermore, the blow moulded part is also used for accommodating hot-fresh air ventilation lines which extend through the interior hollow space of the blow moulded part. As shown in the drawing of DE 196 27 106 A1, the ventilation lines have been made separately from the blow moulded part.

This known floor covering is associated with a disadvantage in that the indentations and their connection channels are open towards the top of the blow moulded part. While the indentations and connection channels are covered by a cover layer, it can nevertheless occur that the carpet floor covering bulges downward in the region of the indentations and the connection channels so that the indentations and connection channels of the blow moulded part become apparent in the carpet floor covering, thus giving the carpet floor covering an unsatisfactory appearance. Furthermore, the sinking of the cover layer or the carpet floor covering into the connection channels impedes the air exchange between the indentations, and thus impedes the acoustic effectiveness of the blow moulded part. Even if the blow moulded part is turned over so that its closed plate-shaped bottom forms the top, which in DE 196 27 106 A1 is however neither shown nor described, narrowing or closure of the connection channels can be expected. This is because the air-impermeable cover layer, which is provided on the open side of the indentations, prescribed according to claim 1 of DE 196 27 106 A1 will cave into the connection channels as a result of the load exerted by the structure above it. The resulting narrowing of the connection channels leads to an impairment in the desired air exchange between the individual air volumes defined by the indentations, and thus leads to an impairment of the acoustic effectiveness of the blow moulded part.

It is the object of the present invention to provide a floor covering of the type mentioned in the introduction which creates an impeccable appearance and improved acoustic effectiveness while ensuring optimum crush-resistance. Furthermore, the floor covering is to be economical to produce.

According to the invention, this object is met by the floor covering defined in claim 1.

The floor covering according to the invention comprises a decorative layer and a crush-resistant blow moulded part that is arranged underneath the decorative layer. On the top, the blow moulded part comprises an essentially closed cover plate while on the bottom it comprises a structural component. The wall thickness of the cover plate is different from that of the structural component, wherein the structural component comprises a plurality of box shaped or cup shaped hollow chambers which are open on one side but closed on the underside, wherein the structural component is backfoamed on its underside. At least some of the hollow chambers which are closed off to the outside form part of a common air space enclosed between the cover plate and the structural component.

In contrast to the blow moulded part shown in DE 196 27 106 A1, in the blow moulded part of the floor covering according to the invention a smooth and essentially non-textured cover plate is provided on the top. The hollow chambers or indentations incorporated in the structural component of the blow moulded part cannot become apparent in the decorative layer of the floor covering, which is preferably a carpet layer. The appearance of the floor covering according to the invention is therefore impeccable. Furthermore, the floor covering according to the invention distinguishes itself by improved sound insulation, in particular when compared to the insert known from DE 196 27 106 A1. This is because in the floor covering according to the invention, the hollow chambers which belong to a mutual air space are not inter-connected by external connection channels, which connection channels may become restricted or even closed off as a result of soft deformable cover layers.

The floor covering according to the invention can be produced economically because the decorative layer or carpet layer can be applied directly to the cover plate. The floor covering according to the invention does not require an additional cover layer of the type arranged between the top of the blow moulded part and the decorative layer or carpet layer in the insert according to DE 196 27 106 A1. This reduces production costs accordingly.

Production of the blow moulded part of the floor covering according to the invention can preferably take place in a corresponding way to the production of the sound-absorber described in EP 0 775 354 B1. The contents of EP 0 775 354 B1, which trace back to the same applicant, are thus fully incorporated into this application.

An advantageous embodiment of the floor covering according to the invention consists of the hollow chambers formed in the structural component of the blow moulded part varying in size and/or depth. In this way the moulded part can easily be adapted to the contour of the floor pan (bottom plate) of the vehicle. Furthermore, as a result of hollow chambers of various sizes and/or various depths, an adaptation in relation to acoustics can also take place in that the size and/or depth of the hollow chambers are/is selected depending on the sound frequencies that occur. In this arrangement it is preferred that the bottoms of the smaller hollow chambers at the same time are less deep than the bottoms of the larger hollow chambers.

According to a further advantageous embodiment of the floor covering according to the invention, between the cover plate and the structural component of the blow moulded part, in the region of the hollow chambers, point-shaped or line-shaped welds are formed between the chamber walls of the hollow chambers and the cover plate. The welds ensure that the adjacent hollow chambers are usually open towards the top, i.e. the cover plate never completely closes the respective hollow chamber. In this arrangement it is in particular possible for a hollow chamber, which preferably has a rectangular or square horizontal projection, to be closed by welds on up to three sides. The welds also improve the stability, in particular the flexural strength, of the blow moulded part.

Preferably, polypropylene, in particular fibre-reinforced polypropylene, is used as a raw material for the blow moulded part.

In particular polyurethane foam material or some other soft foam material can be used for underfoaming or backfoaming the structural component.

According to a preferred embodiment of the floor covering according to the invention, a cable channel, an air conduit and/or a receptacle for accommodating one or several functional parts are integrated in the blow moulded part. As an alternative, or in addition, at least one cable channel can be integrated in the layer made of porous and/or elastic material, which layer is arranged underneath the blow moulded part.

Further preferred and advantageous embodiments of the invention are stated in the subordinate claims.

Below, the invention is explained in more detail with reference to a drawing which shows several embodiments. The following are shown:

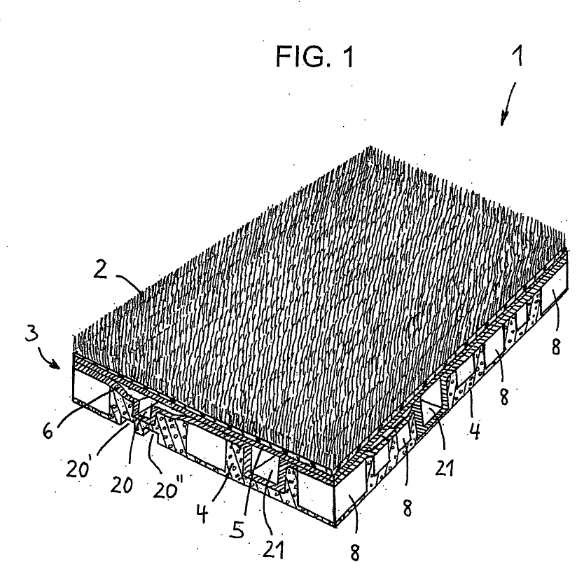

FIG. 1 a perspective view of a section of a floor covering for arrangement on a floor pan of a vehicle, according to a first embodiment;

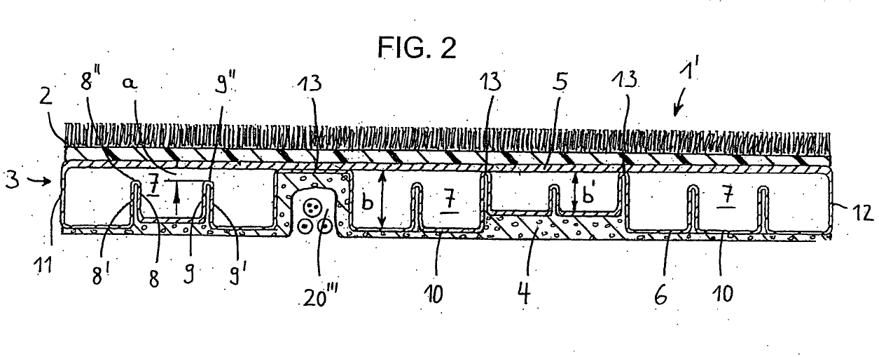

FIG. 2 a cross-sectional view of a floor covering according to a further embodiment;

FIG. 3 a schematic diagram of a blow moulded part of a floor covering according to the invention, with weld lines indicated;

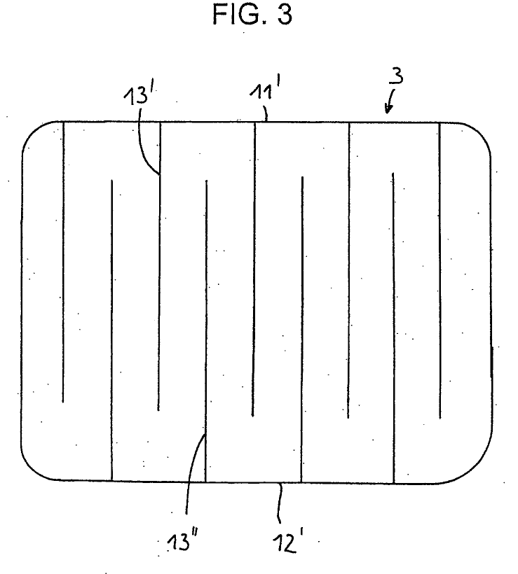

FIG. 4 a cross section of a tubular section as the starting element of a blow moulded part of a floor covering according to the invention;

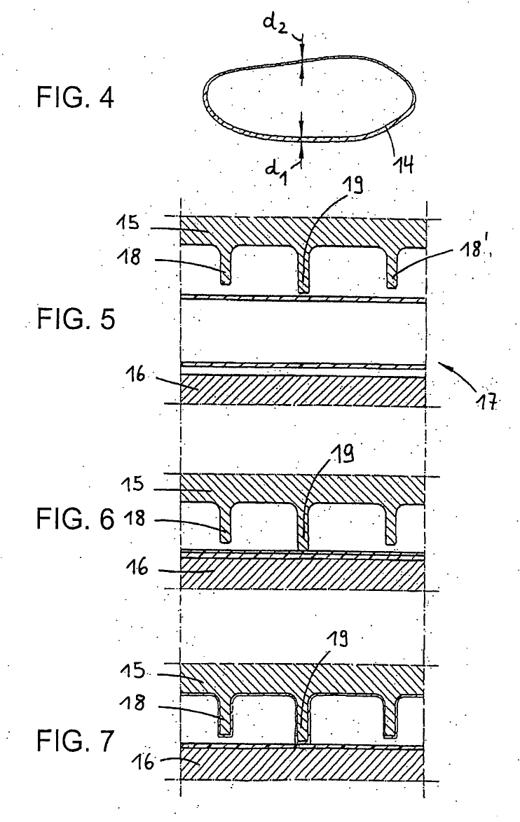

FIG. 5 a partial cross-sectional view of a tubular section according to FIG. 4, placed in a blow mould, before the two halves of the mould are moved together;

FIG. 6 a view according to FIG. 5 with a tubular element in place, after the two halves of the mould have been moved together;

FIG. 7 a view according to FIG. 5 or FIG. 6 after completion of blow moulding before removing the blow moulded part from the mould; and

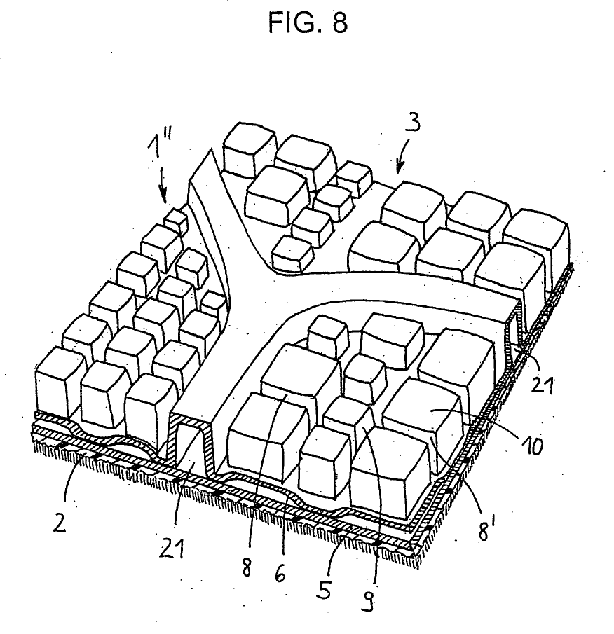

FIG. 8 a perspective bottom view of a floor covering according to a further embodiment, wherein, for improved clarity, the structural component of the blow moulded part is shown on its own, without its associated bottom layer.

The floor covering 1, 1′, 1″, shown in various embodiments, is in particular designed for installation in commercial vehicles (utility vehicles) and comprises a decorative layer or carpet layer 2, a crush-resistant self-supporting blow moulded part 3, also referred to as a sound absorber, and a layer 4 made of PUR foam or some other soft foam material, which layer serves as a substructure to the vehicle floor.

On the top, the blow moulded part 3 comprises a smooth closed cover plate 5, and on the bottom a structural component 6. The cover plate 5 is also referred to as a carrier part. The structural component 6 comprises hollow chambers 7 which are open on one side, namely towards the cover plate 5, which hollow chambers 7 comprise chamber walls 8, 9. The hollow chambers 7 are essentially box shaped or cup shaped. Each hollow chamber 7 comprises a bottom floor 10, which is essentially flat, and flat chamber walls 8, 9, which are essentially arranged so as to be perpendicular in relation to said floor 10.

The cover plate 5 is connected to the structural component 6, namely in two edge regions 11, 12 by an integral transition, and at the face edges which extend transverse to the former by welding. The crush-resistant self-supporting characteristics of the blow moulded part 3 essentially result from the interaction of the structural component 6 and cover plate 5. Preferably, but not necessarily, a greater wall thickness of the cover plate 5 is provided. The carpet floor covering 2 is glued with the carpet backing directly on the cover plate 5 of the blow moulded part 3.

As is in particular shown in FIG. 2, there are several welds 13 in the region of the hollow chambers 7, between the structural component 6 and the cover plate 5. In the embodiment shown, the welds 13 are line shaped. In detail, the chamber walls 8 or 9 are welded along their faces or peaks or transitions 8″, 9″ between two chamber walls 8, 8′, which faces, peaks or transitions face the cover plate 5, to the cover plate 5. It is also possible for spot-type welds to be provided. In the regions in which there are no welds, which as a rule is the case at any rate in relation to one chamber wall 8 of a hollow chamber 7, the peaks or transitions between the chamber walls 8, 8′ are spaced from the cover plate 5, substantially uniformly over the entire blow moulded part for all comparable chamber walls 8, namely a distance a (spacing a). In order to be effective from the point of view of sound technology, the distance a can range from approximately 1 to 4 mm. In this context a distance a of approximately 2 mm is preferred. In this arrangement the distance a is not significantly tied to the depth of the hollow chamber 7 but instead is influenced by the still effective air friction in this distance a. Nonetheless, in relation to the depth b of a hollow chamber 7, a distance a ranging from 3 to 7%, in particular approximately 5%, of the overall depth is preferred.

Furthermore, as indicated in FIG. 3, the welds 13, 13′, 13″ can extend, starting from the respective edges, enmeshed with each other in a chamber-like manner, without being interconnected (in relation to welds starting from opposite edges). The edge regions 11′, 12′, from which the welds 13′, 13″ extend in this arrangement, can preferably be edge regions which are welded anyway.

According to the invention, hollow chambers 7 are thus formed whose chamber walls 8, 9, while of essentially identical depths, are partly welded to the cover plate 5 and partly facing the cover plate 5 forming a free collar and leaving an air gap a between a front face 8″, 9″ of the chamber wall 8, 8′, 9, 9′ and the cover plate 5. At least some, but preferably all, of the hollow chambers 7 form part of a mutual air space enclosed between the cover plate 5 and the structural component 6 of the blow moulded part 3.

As shown in FIGS. 1 and 8 the hollow chambers 7 can differ in size. On the one hand this can be achieved in that the base area of the hollow chambers 7 differs in size, and on the other hand in combination or as an alternative to this in that the bottoms 10 of the hollow chambers 7 are differently spaced apart from the cover plate 5 (compare in particular FIG. 2).

The material used is a thermoplastic, weldable material. For example polypropylene, in particular polypropylene comprising glass fibre, has been found to be suitable.

As diagrammatically shown in FIG. 4, such a blow moulded capsule 3 can be made from an extruded tubular section 14. The tubular section 14 comprises different wall thicknesses d1 or d2 around its circumference.

As shown in FIGS. 5 to 7, such a tubular section 14 for the production of a blow moulded part 3 according to FIG. 1, 2 or 8 is inserted between two halves 15, 16 of a blow mould 17. In this arrangement, the mould half 15 comprises several wall elements 18, 18′, 19, which correspond to the spaces between two chamber walls 8, 8′. It is to be recognised that the wall element 19 is higher than the two other wall elements 18 and 18′ shown.

As is further apparent from a comparison of FIGS. 6 and 7, there can be achieved, after closing of the blow mould 17, an engagement of the regions in question against the mould halves 15, 16 by blowing in air between the thicker and the thinner layer of the tubular section 14. In the region of the wall element 19, which is positioned close to the bottom mould half 16 when the mould is closed, welding between the layer forming the structural component 6 and the layer of the tubular section 14 which forms the cover plate 5 occurs.

As shown in FIGS. 1 and 8, at least one cable channel 20 and/or an air conduit 21 can be integrated in the blow moulded part 3. In this arrangement the cable channel 20 and/or the air conduit 21 is formed in the structural component 6, i.e. in one piece with the blow moulded part 3. Furthermore, it is within the scope of the invention to integrate one or several receptacles (not shown) for accommodating functional components, for example electronic components, in the blow moulded part 3.

In the embodiments shown in FIGS. 1 and 2, in the foam material layer arranged underneath the blow moulded part 3 one or two channels are formed whose purpose it is to accommodate electrical lines and/or lines conveying a liquid.

In the embodiment according to FIG. 8, for the sake of clarity, the foam material layer 4 is not shown. It is to be recognised in particular that the hollow chambers are arranged offset from one another such that there results essentially no continuous fold line, in particular along the main axes of the blow moulded part 3. In a horizontal direction of extension of two opposing chamber walls 8, 8′ as a rule a chamber wall 9 of a further hollow chamber is arranged, which chamber wall 9 extends transversely to the former. This results in a high integral stability of the blow moulded part 3. At the same time, the described spacing of individual chamber walls from the cover plate 5, and the offset arrangement in relation to each other, also results in a sound-technology effect. Overall, the described distance a in connection with the sizes of the hollow chambers and the fine adjustment of the distance a can be used for frequency-related adjustment of the blow moulded part 3, which blow moulded part 3 acts as a sound absorber.

The offset arrangement of the hollow chambers 7 in relation to each other, and the various sizes of the individual hollow chambers 7 results in excellent overall stability of the blow moulded part 3. Not least, this design also makes it possible to design some individual walls of the hollow chamber 7 to form a free collar in relation to the cover plate 5. Despite the small distance a described, no such deformation of the blow moulded part 3 can occur which would result in a narrowing of the distance a.

1. Crush-resistant, acoustically effective floor covering for a motor vehicle, in particular a commercial vehicle, comprising a decorative layer (2) and a crush-resistant blow moulded part (3) arranged underneath the decorative layer, wherein on the top, the blow moulded part (3) comprises an essentially closed cover plate (5) while on the bottom it comprises a structural component (6), wherein the wall thickness (d1) of the cover plate (5) is different from that (d2) of the structural component (6) and wherein the structural component (6) comprises a plurality of box-shaped or cup-shaped hollow chambers (7) which are open on one side but closed on the underside, wherein at least some of the hollow chambers (7) which are closed off to the outside form part of a common air space enclosed between the cover plate (5) and the structural component (6), and wherein the structural component (6) is underfoamed by foam material (4).

2. The floor covering according to claim 1, wherein the hollow chambers (7) differ in size and/or differ in depth.

3. The floor covering according to claim 1, wherein the decorative layer (2) is directly glued to the cover plate (5) of the blow moulded part (3).

4. The floor covering according to claim 1, wherein the decorative layer (2) is a carpet floor covering.

5. The floor covering according to claim 1, wherein a layer (4), arranged underneath the blow moulded part (3), is made from foam material and non-woven material.

6. The floor covering according to claim 1, wherein the layer (4), which is arranged underneath the blow moulded part (3), is made from a soft foam material, preferably a polyurethane foam material.

7. The floor covering according to claim 1, wherein at least one cable channel (20), at least one air conduit (21) and/or at least one receptacle for accommodating one or several functional components are integrated in the blow moulded part (3).

8. The floor covering according to claim 1, wherein at least one cable channel (20, 20, 20) is integrated in the layer (4) made of porous and/or elastic material, which layer (4) is arranged underneath the blow moulded part (3).

9. The floor covering according to claim 1, wherein the blow moulded part (3) is made from polypropylene, preferably from fibre-reinforced polypropylene.

10. The floor covering according to claim 1, wherein between the cover plate (5) and the structural component (6) of the blow moulded part (3) in the region of the hollow chambers (7) there are spot-shaped or line-shaped welds (13, 13, 13) between chamber walls (8, 9, 8, 9) of the hollow chambers (7) and the cover plate (5).

11. The floor covering according to claim 10, wherein hollow chambers (7) are formed whose chamber walls while of essentially identical depths are partly welded to the cover plate (5) and partly face the cover plate (5) forming a free collar and leaving an air gap (a) between a front face of the chamber wall (8,8,9,9) and the cover plate (5).

12. The floor covering according to claim 1, wherein on the edge side there is a one-piece transition between the structural component (6) and the cover plate (5).
